(19) United States
(12) Patent Application Publication
(10) Pub. No.: US 2006/0152344 A1
(43) Pub. Date: Jul. 13, 2006

(54) Powerline Communication Network Handoff

(76) Inventor: Richard A MOWERY JR., McGregor, TX (US)

Correspondence Address: Richard A Mowery Jr, 911 Morning Sun Lane, McGregor, TX, 76657, US

(21) Appl. No.: 10/519,912

(22) PCT Filed: Dec. 7, 2002
(86) PCT No.: PCT/US02/39275

§ 371 Date: Dec. 30, 2004

(51) Int. Cl. G05B 11/01

(52) U.S. Cl. 340/310.11

(57) ABSTRACT

This patent relates to the handoff of an untethered device (493) connected to a tethered device (495) communicating on a power line communication (PLC) network (499) to another device communicating on a PLC network or communicating with a conventional communication network or communicated on a mesh communication network. An additional embodiment of the present invention is the bridging (662) of a first communication network (660) over a PLC network to a second communication network (664) and the switching into or out of a PLC network between two communication networks bridged through a device connected to a PLC network (499) such that the first communication network (660) or second communication network (664) disconnects from the PLC network while a third communication network (665) connects to the PLC network (499).

### CROSS REFERENCES TO RELATED PATENT

This International application is related to the following U.S. application Ser. No. 09/632,320 which was filed on Aug. 4, 2000, and entitled “A System for Coupling Wireless Signals to and from a Power Transmission Line Communication System” by Richard A. Mowery Jr.; which is hereby incorporated herein by reference.

### TECHNICAL FIELD

This invention relates to power line communication, specifically to a mechanism for handing off wireless and wired information to and from a power line communication (PLC) network using a power line communication (PLC) system.

### BACKGROUND ART

Thomas Edison was the inventor of the electric light bulb which has influenced in one way or another every human being in the world. U.S. Pat. No. 223,898 is a basic building block of many inventions considering the electric light bulb as prior art. The electric light bulb installs quickly and is cost effective compared to the wax candle or oil-burning lamp. However, Thomas Edison never envisioned that his invention would one day help third world countries and rural areas obtain the necessary technology to compete with urban centers. The light bulb was used as a way to communicate information by turning on and off the bulb in a pattern. However, the light bulb was never operated as a wireless communication base for sending and receiving large bandwidth data. Moreover, the light bulb was never envisioned to interface with a power line communication system. To date, however, no system has been proposed which makes effective use of the extensive and growing bidirectional networks of power transmission lines already existing or installed, particularly in urban and suburban areas, for wireless data communication purposes.

In all cities around the world, street poles illuminate the night for safety and ease of visibility. However, the sunlight detectors that sit on top of these poles have never operated as a wireless communication base for sending and receiving large bandwidth data. Moreover, the sunlight detector which easily plugs into the street pole through an electrical outlet was never envisioned to interface with a power line communication system. To date, however, no system has been proposed which makes effective use of the extensive and growing bidirectional networks of street light poles for wireless communication with handoff.

High capacity, low cost portable grade radiotelephone service will place additional burdens on the urban cellular frequency spectrum. Additionally, the cost of sites for radio base stations and antenna installations, and difficulties in construction and maintenance access during busy road traffic periods, require a more cost effective means for providing wireless communications if the urban and rural demand for service is to be met.

Because of the well established power transmission infrastructure, and the increasing need for higher speed, higher capacity, and greater distribution of information of all types over great distances, particularly wireless communications today, there is a continuing and increasing need to develop a satisfactory and cost effective communication system which takes advantage of the vast and well established power transmission line distribution network already in place throughout the world.

To date, there is no prior art that allows a wireless device to be handed off from a wired network such as an Ethernet network, a fiber optics network, a local area loop, a standard cellular network, a home power line network, a DSL network, a Cable modem network, a Cable network, a copper line network, a POTS line network, or packet based network to and from a power line communication (PLC) network or vice versa. Moreover, there is no prior art that allows a wireless device to be handed off from a mesh communication network to a power line communication (PLC) network or vice versa. Furthermore, there is no prior art that allows two networks connected through a bridge device to a power line communication network to be switched from the first network through the bridge device to the second network without loss of data.

### DISCLOSURE OF INVENTION

These and other problems are generally solved or circumvented, and technical advantages are generally achieved, by preferred embodiments of the present invention which provides for a handoff of an untethered device from a tethered device connected to a power line communication system to a communication network which can be a power line communication network or a wired network or mesh network. The present preferred embodiment also provides for a handoff of an untethered device from a communication network which can be a power line communication network, a wired network, or a mesh network and a tethered device connected to a power line communication system.

A second embodiment of the present invention is the bridging of a first communication network over a PLC network to a second communication network and the switching into or out of a PLC network between two communication networks bridged through a device connected to a PLC network such that the first communication network or second communication network disconnects from the PLC network while a third communication network connects to the PLC network.

Accordingly, besides the objects and advantages of a handoff over a power line communication (PLC) system described in the above patent, several objects and advantages of the present invention are to provide a system and method for handoff over PLC system that can seamlessly handoff an untethered device from a communication network to a power line communication network or vice versa without the loss of data. The communication network can be a tethered device connected to a wired network comprising a PLC network, an Ethernet network, a fiber optics network, a local area loop, a standard cellular network, a home power line network, a digital subscriber line, a cable modem network, a cable television network, a copper line network, a POTS line network, a packed based network, satellite network, or other similar network creating a mesh network.

Another object and advantage of the present invention is to provide a system and method for handoff using a PLC system that can initiate a handoff of an untethered device between a tethered device within a first cell to a wired network within the first cell or a second cell such that the untethered device disconnects from the tethered device while the tethered device connects to a communication network. Moreover, the PLC network can initiate a handoff of an untethered device between a communication network within a first or a second cell to a tethered device within the first cell such that the untethered device disconnects from the communication network while the untethered device connects to the tethered device. Furthermore, the PLC network can initiate a handoff of an untethered device between a communication network within a first cell or a second cell and a mesh communication network connected to a power line communication system within the first cell or second cell such that the untethered device disconnects from the communication network while the untethered device connects to a the mesh communication network.

Another object and advantage of the present invention is to provide a system and method for handoff using a PLC system that can seamlessly handoff a wired communication network running over a PLC network with a second communication network such that the second communication network is switched into or out of the PLC network.

Another object and advantage of the present invention is to provide a system and method for handoff using a PLC system to evaluate if the positioning or received signal power of an untethered device is more optimally connected to a power line communication network, a communication network, a mesh communication network connected to a power line communication system, or a tethered device. This evaluation can be accomplished by the untethered device, tethered device, main office server, mesh communication network, or communication network.

Another object and advantage of the present invention is to provide a system and method for handoff using a PLC system which can be distributed by vending machines, general stores, government agencies, education organizations, internet shopping sites or any other retail method

Another object and advantage of the present invention is to provide a system and method for handoff using a PLC system that cannot be altered for safety and security concerns. This patent can also allow a specified individual, company, or entity to dynamically increase or decrease the level of security depending on the physical location.

Another object and advantage of the present invention is to provide a system and method for handoff using a PLC system that can be effortlessly clamped onto and be powered by any power transmission line or effortlessly screwed into a light bulb outlet or attached to or near a light bulb or street light. This allows for an easily installable wireless network by simply screwing in a halogen, fluorescent, incandescent, infrared, or ultraviolet light bulb. The devices can illuminate city streets and major highways. A PLC network that does not have to directly connect with the power transmission line through magnetic inductive coupling is easily installed. A sunlight detector can be used as an access point to which a PLC network can function as a sunlight detector to switch on a street light depending on light conditions. Therefore, a rollout of a wireless power communication system can be accomplished in a relative short time by just changing out the street lamp bulbs. Moreover, a known apparatus like the light bulb can be installed by ordinary individuals. A sunlight detector or light bulb is environmentally and visually friendly compared to obtrusive and expensive cellular towers.

Another object and advantage of the present invention is to provide a system and method for handoff using a PLC system that has many different forms and sizes of the antenna such as the dipole antenna, sectional antenna, omni-directional antenna; directional antenna, retractable antenna or the planar antenna.

A PLC network can be implemented using direct spread spectrum, frequency hopping, magnetic, OFDM, ultra-wideband, impulse, or other communication method supporting power transmission line communication through an outlet attachment, power transmission line attachment, or integrated circuit. A PLC network can have a wireless component which is secure and has a high bandwidth is based on the techniques of modern modulation of the signal such as analog modulation, frequency modulation, amplitude modulation, phase modulation, QPSK modulation, GSM, CDMA, TDMA, WCDMA, CDMA2000, UMTS, or ultra-wide band time domain based technology. A PLC network can communicate using infrared, ultraviolet, laser, visible light, magnetic, ultrasonic, acoustic, impulse, ultra-wideband, or electromagnetic energy and use any combination or individual upgradeable standard communication protocol such as Bluetooth, IEEE 802.15, IEEE 802.16, Wireless Man, IEEE 802.11, ultra wideband, GSM, CDMA, EDGE, GPRS, CDMA, TDMA, 3G, 4G, OFDM, flash OFDM, FM, AM, QPSK, PSK, frequency hopping, spread spectrum, or other communication method supporting handoff.

Another object and advantage of the present invention is to provide a system and method for handoff using a PLC system that has a secure protocol that can send video and data information to and from objects such as home appliances, consumer electronic devices, computer devices, motor vehicles, airplanes, boats, lighting, smart card readers, credit card readers, or security systems. This communication network can be used to securely purchase or sell objects.

Another object and advantage of the present invention is to provide a system and method for handoff using a PLC system that creates a secure personal area network which can seamlessly transfer connected devices to other local personal area networks, dialup networks, cable modem networks, digital subscriber line networks, cellular networks, or wide area networks. A PLC network can create a personal area network that can be easily integrated with a digital signal processor or microprocessor. The digital signal processor or microprocessor can share its resources and processing power with other communication networks to create a parallel processing network. Consumers and customers can share with each other wireless devices or systems for coupling wireless devices to a power communication system. Wireless subscriber devices can share processor and memory resources with other nearby devices to create a multiprocessor unit.

Another object and advantage of the present invention is to provide a system and method for handoff using a PLC system that can instantaneously track the movement of products, individuals, criminals, or individuals carrying visas and passports or function as a radar system for security and identification purposes. This network can act like a global positioning system or location system to determine exact distances and position of objects. This network can instantaneously track consumers using electronic tickets, needing to pay tolls or taxes, or track monetary instruments. It has the ability to track and control public transportation or motor vehicles according to safety and government regulations. This communication network can provide important information to disabled people such as object positioning. It can provide for more exact locations of wireless subscribers in which the local area of a site is measured in feet instead of miles. It can automatically independently search and locate itself and others devices on the Internet by a specific identification number or domain name.

Another object and advantage of the present invention is to provide a system and method for handoff using a PLC system that can find other networks and wireless devices so as to limit or expand its transmission power to exactly match the distance between these networks and wireless devices. This allows for dynamically changing output signal power to match environmental interference and to minimize battery usage.

Another object and advantage of the present invention is to provide a system and method for handoff using a PLC system is to allow untethered devices to retrieve statistics, evaluate fingerprints, organize data into the correct network protocol, compress data in real time, understand voice content, read bar codes, and manipulate data by conventional algorithms. This allows for the coupling of wireless telephone, television or radio signals to a PLC network.

Another object and advantage of the present invention is to provide a system and method for handoff using a PLC system that can offer increased wireless bandwidth, increase in the number of wireless sites, and decrease in total power output. It can provide for more wireless subscribers per square area compared with conventional wireless communication sites. It can create more bandwidth per user compared with conventional wireless communication sites while allowing for the instantaneous handoff of wireless subscribers as they move around from site to site. The communication network can instantaneously synchronize various databases such as tasks, addresses, and calendar to various devices while allowing for multiple connections to several nearby devices which can act as portals to the power communication system to form a mesh communication network. A mesh communication network can provide through the use of private individuals that are willing to share their electrical outlet resources in exchange for usage of other private individuals' electrical outlet resources cost effective and publicly available network that can be used for emergency communication in urban and rural areas. Conversely, most private corporations are not willing to share their expensive assets such as microwave or cellular towers.

Another object and advantage of the present invention is to provide a system and method for handoff using a PLC system that is to decrease the overall radiation of a site to be exactly proportioned by the distance from nearby sites. This creates a wireless network with power that exactly covers an area through dynamic power correction. Conversely, a conventional communication tower radiates static power distribution with excessive radiation. It also allows for the construction of a complicated wireless network that can be quickly installed and used in rural areas with no conventional wireless communication system. This wireless network can provide wireless statistical information about lighting usage to electric power companies or provides for more coverage than a cellular or microwave tower because there are more electrical outlets and street lights compared to cellular or microwave towers.

Another object and advantage of the present invention is to provide a system and method for handoff using a PLC system that provides for wireless communications along any road with power transmission lines. This is especially useful in rural areas without a cellular infrastructure. This network can transmit and receive information from a wireless device that is placed in a plastic casing and placed on the side of the road as a reflector or in the center of the road as a lane separator. These devices can talk with other wireless devices or other nearby plastic cases to create a mesh network. Thus, a long distance-hopping scheme can be accomplished in rural areas. This means that when no clear transmission line is present, information can be sent from wireless device to wireless device until a coupling system can be found.

Another object and advantage of the present invention is to provide a system and method for handoff using a PLC system that allows multi-player recreation computer games to be played across the PLC network.

Another object and advantage of the present invention is to provide a system and method for handoff using a PLC system that allows radio frequency identification tag to consist of a wireless transmitter, microprocessor, and memory. The memory can be non-volatile memory such as DRAM, SRAM, magnetic memory, or Ferro-electric memory. The radio frequency identification tag will be able to talk to nearby wireless devices that are freestanding or connected to a PLC network. A radio frequency identification tag can be attached to objects such as personal items, retail inventory, toll passes, monetary instruments, luggage, and automobiles. These tags and network can be created with standard silicon fabrication, silicon fabricated in three dimensional semiconductor balls, or a plastic fabricated circuit.

Another object and advantage of the present invention is to provide a system and method for handoff using a PLC system that can also use other devices to facilitate coupling of a radio signal to a power transmission line such as power transformers, noise suppression devices, electrical power strips, home appliances, home electronic devices, a lighting sensor attached to a street lamp pole, power lines, street lights, electric meters, and traffic lights. Essentially, the invention can couple radio signals to a power transmission line through many different interface means that plug in to an outlet, screw into a socket, splice into a power line, or hang from a street lamp.

Another object and advantage of the present invention is to provide a system and method for handoff using a PLC system that can eliminate the receiver and only be able to send data from the PLC network through the transmitter. The power line communication network can also eliminate the transmitter and only be able to receive data to the PLC network through the receiver. The PLC network can also eliminate both the transmitter and receive and only send radio frequency signals through the power communication network. The PLC network can co-locate multiple antennas around it so as to boost or bring in different wireless signals.

Another object and advantage of the present invention is to provide a system and method for handoff using a PLC system that is to have a simple method to handoff a wireless device to and from a PLC network. This can consist of determining positioning or signal power of all untethered devices and tethered devices within wireless range. Next, the network can vary or keep constant the signal power output of all untethered devices in proportion to positioning or received signal power between each untethered device and farthest device within wireless range. It can vary or keep constant the signal power output of all tethered devices in proportion to positioning or received signal power between each tethered device and farthest device within wireless range. This can create a new first cell with new wireless radius that may or may not overlap with a second cell by adjusting signal power. Next, it can communicate through said PLC network, or through a communication network, or through wireless communication to analyze the tethered device's or the communication network's or the mesh communication network's position or received signal power from the untethered device, and the capacity of the tethered device or the communication network or the mesh communication network to connect to the untethered device.

Still further objects and advantages will become apparent from a consideration of the ensuing description and drawings. Similar constructions which do not depart from the spirit and scope of this invention set forth in the claims or embodiment should be considered the equivalent.

### BRIEF DESCRIPTION OF DRAWINGS

For a more complete understanding of the present invention, and the advantages thereof, reference is now made to the following descriptions taken in conjunction with the accompanying drawing, in which:

FIG. 1 is a diagrammatic illustration of a tethered device connected to a power line communication system.

FIG. 2 is a diagrammatic illustration of an untethered device.

FIG. 3 is a diagrammatic illustration of the presently preferred system of the present invention capable of carrying out the presently preferred method of the present invention.

FIG. 4 is a diagrammatic illustration of a Mesh Network.

FIG. 5 is a diagrammatic illustration that represents a power distribution network that can distribute electrical power to customer's premise through power transmission line communication method and system.

FIG. 6 is a diagrammatic illustration of an additional embodiment in accordance with the present invention.

### MODE(S) FOR CARRYING OUT THE INVENTION

### Detailed Description of Best Mode for Carrying out the Invention

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a power line communication (PLC) system that provides for handoff of an untethered device from a tethered device connected to a PLC network to a communication network. A communication network is a tethered device connected to a wired network comprising a PLC network, an Ethernet network, a fiber optics network, a local area loop, a standard cellular network, a home power line network, a digital subscriber line, a cable modem network, a cable television network, a copper line network, a POTS line network, a packed based network, or other similar network creating a mesh network. A mesh network comprises several untethered devices individually wirelessly connected together so that the last untethered device is connected to a tethered device connected to a wired network so as to bridge the farthest untethered device onto said tethered device or an individual untethered device wirelessly connected to a tethered device connected to a wired network or communication network.

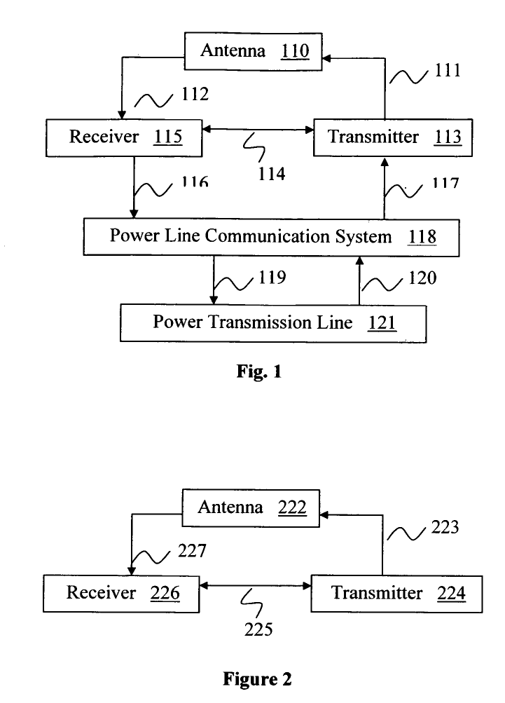

Referring now to the drawings in detail, and initially to FIG. 1, a tethered device is electrically coupled to a power line communication system claimed. The system has antenna 110 which allows for the reception and transmission of impulse or conventional modulated signals. An antenna is directly connected to a conventional receiver 115 by using a low impedance path 112. The antenna is also directly connected to a conventional transmitter 113 by means of a low impedance path 111. A receiver 115 is directly connected to transmitter 1 13 by using a bidirectional coupling means 114. The bi-directional coupling means 114 allows for exchange of data from the receiver to the transmitter and from the transmitter to the receiver. Receiver 115 sends data to a power communication system 118 through a low impedance path 116. Transmitter 113 receives data from the power communication system 118 through a low impedance path 117. The power communication system 118 sends data signals to a power transmission line 121 by a power communication system send method 119. The power line communication system receive method 119 uses a secure communication protocol that can be directly altered or updated using a power transmission line 121. The power communication system 118 receives data signals from power transmission line 121 by a power communication system transmit method 120. The power line communication system transmit method 120 uses a secure communication protocol that can be directly altered or updated using a power transmission line 121. A low impedance path 111 and low impedance path 112 is made out of a low impedance material such as copper. The bi-directional coupling means 114 specified in the claims that use the low impedance path can be the same low impedance path used by all bidirectional coupling means.

Referring now to FIG. 2, an untethered device not physically connected to a power transmission line but able to wirelessly communicate with tethered devices is claimed. The system has an antenna 222 which allows for the reception and transmission of impulse or conventional modulated signals. An antenna is directly connected to a conventional receiver 226 by using a low impedance path 227. The antenna is also directly connected to a conventional transmitter 224 by means of a low impedance path 223. A receiver 226 is directly connected to transmitter 224 by using a bidirectional coupling means 225. The bi-directional coupling means 225 allows for exchange of data from the receiver to the transmitter and from the transmitter to the receiver. A low impedance path 227 and low impedance path 223 is made out of a low impedance material such as copper. The bi-directional coupling means 225 specified in the claims that use the low impedance path can be the same low impedance path used by all bidirectional coupling means.

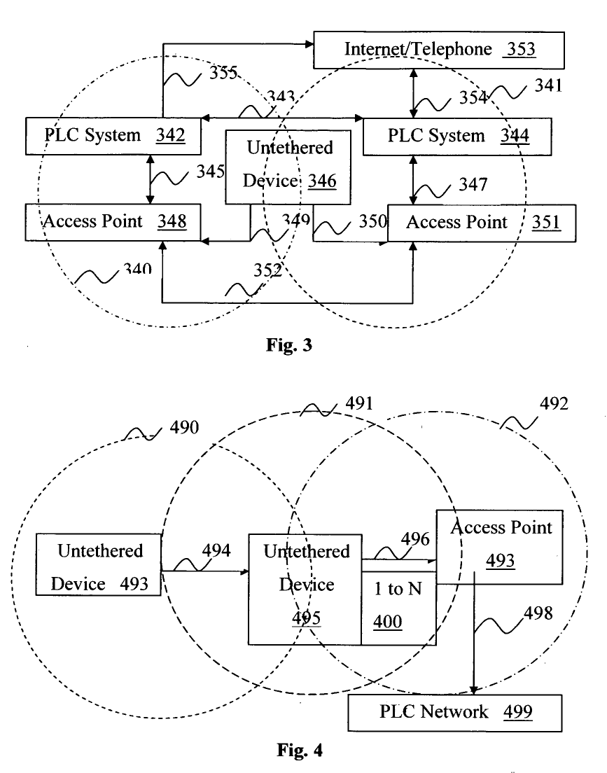

Referring now to FIG. 3, a system for handoff using a power line communication system is claimed. First access point 348 consists of a tethered device described in FIG. 1. The first access point 348 can communicate wirelessly over its first cell radius 340. It has the ability to communicate over a first power line communication system 342. It can also wirelessly communicate with other access points such as the second access point 351. It can also communicate with untethered device 346. First power line communication system 342 can be integrated into first access point 348 or can be a separate entity. It can communicate with other power line communication systems such as second power line communication system 344. By communicating with other power line communication systems, this can form a power line communication network. The second access point 344 can communicate wirelessly over its second wireless radius 341. Second wireless radius 341 may or may not overlap with the first wireless radius 340. It has the ability to communicate over the second power line communication system 344. It can also wirelessly communicate with other access points such as the first access point 348. It can also communicate with wireless devices such as untethered device 346. The first power line communication system 342 is connected to the worldwide internet or telephone system 353 using Ethernet 355 or similar connection such as ATM. The telephone system can be a cellular telephone system. The second power line communication system 344 can also be connected to the worldwide Internet or telephone system 353 using Ethernet 354 or similar connection such as ATM. Untethered device 346 as shown in FIG. 2 is initially connected to first access point 348. The untethered device 346 can communicate indirectly through the power line communication network to the worldwide Internet or telephone system 353. As the untethered device 346, moves from first wireless radius 340 to the second wireless radius 341, there is a handoff of the untethered device 346 such that the first access point 348 disconnects from the untethered device 346 while the second access point 351 connects to it. The handoff communication can be sent wirelessly between the first access point 348 and the second access point 351 by using a wireless communication means 352. Wireless communication means 352 could also mean a mesh communication network. The handoff communication can also be sent over the power line communication system using power line connection 345 to first power line communication system 342 which can talk over a power transmission line to second power line communication system 344. The second power line communication system 344 can then send this handoff request by talking to the second access point 351 using a power line connection 347. The untethered device 346 can talk with multiple access points at the same time such as first access point 348 using first wireless connection 349 and second access point 351 using second wireless connection 350. The handoff of untethered device 346 from first access point 348 to second access point 351 can be accomplished by evaluating the power output or positioning of the untethered device 346, and then evaluating if the untethered device 346 would be more optimally connected to the first access point 348 or the second access point 351.

Referring now to FIG. 4, a mesh communication network using a power line communication network is shown. A first untethered device 493 with first cell radius 490 can be wirelessly transferred to a second untethered device 495 using a wireless connection method 494. The second untethered device 495 with second cell radius 491 can be connected through an access point 493 to a power line communication network 499 using a power line communication system 498. The access point 493 has the ability to wirelessly communicate over a third cell radius 490 and to communicate over a power line communication network 499 using a power line communication system 498. The first cell radius 490 may overlap with second cell radius 491 or third cell radius 492. The second untethered device 495 may be connected to a third untethered device or a fourth untethered device such that there are one to N 400 (where N is unlimited number of) untethered devices connected to access point 493. This allows for first untethered device 493 to be connected to power line communication network 499 thus creating a mesh communication network using a power line communication system 498.

Referring now to FIG. 5, a power distribution network that can distribute electrical power to a customer's premise through power transmission line communication method and system is shown. Power substation 570 sends power over a medium voltage line 574 to the first access point 575. The first access point 575 can have a first cell radius 570. The first access point 575 can have a power line communication system and method integrated into it. The first access point 575 can be integrated into a sunlight detector which can pass the power along a medium voltage line 576 to second access point 577. The first access point 575 can also turn on and turn off a street light attached to the medium voltage line or low voltage line. Second access point 577 can be an apparatus attached around the medium voltage line 578. The second access point 577 can have a power line communication network integrated into it and the ability to wirelessly communicate over second cell radius 571. It can pass power from medium voltage line 576 to medium voltage line 578. Medium voltage line 578 can pass power through the third access point 579. The third access point 579 can have a power line communication network integrated into it and wirelessly communicate over third cell radius 572. Third cell radius 572 may or may not overlap with second cell radius 571 and first cell radius 570. Access point 579 can pass power from the power substation 570 over a medium voltage line 580 to a customer transformer 581. The customer transformer 581 may pass power and information through it to a low voltage power line 582. An information decoupler or pass through method may be used to pass power line communication information to a customer 584. Power may be passed to customer 584 through the low voltage power line 582.

### Operation of Best Mode for Carrying Out the Invention

To date, however, no system has been proposed which can make effective use of the extensive and growing bi-directional networks of power transmission lines already existing or installed, particularly in urban and suburban areas, for wireless data communication purposes.

The best mode of practice of the invention is divided into two parts as shown in FIGS. 1-5. The first part is a tethered device which is physically attached to a power transmission line, the second part is an untethered device, and the third part is a handoff of the untethered device from a first tethered device to a second tethered device or from a second tethered device to a first tethered device. A PLC network can consist of multiple tethered devices with the ability to communicate and handoff untethered devices to other tethered devices attached to the PLC network, a communication network, or a mesh network.

A communication network can be a tethered device connected to a network comprising a PLC network, an ATM network, an Ethernet network, a Gigabit Ethernet network, a PCI-Express network, a fiber optics network, a local area loop, a standard cellular network, a home power line network, a digital subscriber line network, a cable modem network, a cable television network, a copper line network, a plain old telephone subscriber line network, a packet based network, an 802.11 network, a Bluetooth network, a ultra-wideband network, or other similar network creating a mesh network.

A mesh communication network comprises several untethered devices individually wirelessly connected together so that the last untethered device is connected to a tethered device connected to a communication network so as to bridge the farthest untethered device onto the tethered device connected to a conventional communication network. A mesh communication network can also comprise an individual untethered device wirelessly connected to a tethered device connected to a communication network which can be a network comprising a power line communication network, an ATM network, an Ethernet network, a Gigabit Ethernet network, a PCI-Express network, a fiber optics network, a local area loop, a standard cellular network, a home power line network, a digital subscriber line network, a cable modem network, a cable television network, a copper line network, a plain old telephone subscriber line network, a packet based network, an 802.11 network, a Bluetooth network, or a ultra-wideband network.

The tethered device consists of a transceiver or divided into two parts which is the transmitter and receiver. The receiver can capture secure data that includes voice, video, and telecommunication information. The receiver captures digital and analog signals that are modulated with high or low frequency carriers. The carrier has a sub-carrier that is modulated with a conventional modulation technique such as analog modulation, frequency modulation, amplitude modulation, phase modulation, QPSK modulation, GSM, CDMA, TDMA, ultra-wide band, or time domain based technology. One method uses impulse modulation in accordance with ultra-wide band time domain based technology. Impulse modulation is a modern modulation technique that decreases power output while ten fold increasing the data bandwidth. The sub-carrier also uses impulse modulation is the best mode of modulation. The receiver can also receive infrared, ultraviolet, laser, visible light, magnetic, ultrasonic, acoustic, impulse, ultra-wideband, or electromagnetic energy. The second part of the tethered device is a transmitter. The transmitter can send secure data that can be modulated with any conventional technique. Both the transmitter and receiver will be able to talk to other wireless devices through an antenna and a secure standard protocol such as Bluetooth, IEEE 802.16, IEEE 802.15, IEEE 802.11, ultra-wideband, GSM, CDMA, EDGE, GPRS, CDMA, TDMA, 3G, 4G, OFDM, flash OFDM, or other communication method supporting handoff. The antenna can be retractable, hidden, or fixed. The tethered device also has a power line communication system. The best mode of practice uses a PLC system that is OFDM based which interfaces with the transmitter and receiver through a low impedance path. The PLC system can also be implemented using direct spread spectrum, frequency hopping, magnetic, OFDM, ultra-wideband, and impulse. The PLC system may be one tethered device that is connected to other devices to form a power line communication network. The low impedance path is an electrical connection that uses a low impedance material such as copper. The tethered device's parts can be entirely housed in a sunlight photo detector attached to a utility pole, or in an apparatus screwed into a light socket, or an enclosure inductively attaching around a power transmission line, or an enclosure plugging into an electrical outlet, or an enclosure hanging from a utility pole.

The cost effective light bulb integrated with a fixed wireless unit that can send and receive data over a PLC network can be rolled out very quickly throughout a municipal or rural area. A halogen light can also be integrated with the antenna, receiver, transmitter, and a PLC network. The integrated system may have a light detector to allow the system to turn on and off the light in relation to the time of day. This cost effective integrated system can be installed to allow for substantial coverage of local wireless subscriber devices by just replacing the existing street light bulbs. This could be accomplished in a fraction of the time that it takes to install a wireless communication network such as a microwave tower. Moreover, the installation could be accomplished by ordinary individual compared to a professional microwave tower installer. The wireless communication light bulb can also be introduced to the office site and home environment. This would allow an individual to connect to the Internet, to wirelessly connect their computers over a local area wireless network, to receive and send video conferencing, and to receive and send voice data free from building interference. By integrating a fixed antenna, transmitter, receiver, and power communication system inside a sunlight detector, a tethered device that is physically attached to a power transmission line can be created. A sunlight detector can be easily switched in and out of the socket of a street light. Also, the sunlight detector always has electricity unlike a light bulb. By placing the antenna, transmitter, receiver, and power communication system inside an enclosure that the electric light bulb can screw its threads into just like an electrical socket, a tethered device that electrically and physically attaches to a power transmission line can be produced. An additional enclosure can attach to any power transmission line by simply attaching around a power transmission line. The additional enclosure can be supplied by power by inductively coupling to the magnetic component or electrically coupling to the power transmission line. It also can send and receive data through a PLC system, and send and receive data from and to any wireless subscriber device using a standard secure protocol.

The use of a microwave tower is expensive, is non-upgradeable, needs professional installation, needs an extensive installation period, is bandwidth limited, is frequency limited, is coverage area limited, does not function in rural areas, works independently of other microwave towers, needs special construction governmental permits, has constant output power, has high signal radiation, is environmentally unfriendly, and has a large visual profile. The use of a network of street lights with a wireless sunlight detector integrated with an antenna, receiver, transmitter, and a PLC system is cost effective, up-gradable, easily installable in seconds, has a high bandwidth, has a large frequency range, can cover large areas including rural areas, works together with nearby light bulbs integrated with an antenna, receiver, transmitter, and PLC system, needs no special construction permit, has dynamic output power, has low signal radiation, is environmentally safe, has a low profile, and is a commodity item. The receiver and transmitter would operate at low power output and could use a free UNII frequency without a frequency permit from a governmental regulatory body such as the FCC. The microwave tower would need FCC approval to function. The use of a wireless subscriber device with a microwave tower is billed on minute-by-minute bases because private corporations own the towers. The use of the access to the tethered device could be billed on a monthly surcharge because private individuals, government agencies, and private corporations would own and borrow the light bulbs or sunlight detector's communication ability. A tethered device attached to the power line communication system can repeat data from other tethered devices attached to the PLC network, a communication network, a mesh network, or a wireless network.

A tethered device can calculate distances to any nearby wireless device. By transmitting a time-synchronized synchronization signal to the device from at least three different nearby devices, the time-synchronized synchronization signal provides time information that can be used to position the wireless device. The system by determining the location of nearby device, can correct the power output so as to limit or expand its transmission power to exactly match the distance between nearby devices. A tethered device can have an ability to accomplish a handoff of a wireless device from itself to another tethered device. A tethered device can also have other wireless abilities, protocols, or methods that do not support wireless handoff integrated within the device. A good example of this is the integration of 802.11 protocol which does support a handoff with a point to point backhaul microwave or laser that does not support handoff.

The second part of this invention is an untethered device. An untethered device consists of an antenna, receiver, and transmitter. The untethered device may move around a city or rural area and still have the ability to communicate using a protocol such as such as Bluetooth, IEEE 802.16, IEEE 802.15, IEEE 802.11, ultra-wideband, GSM, CDMA, EDGE, GPRS, CDMA, TDMA, 3G, 4G, OFDM, flash OFDM, or other communication method supporting handoff. A secure communication protocol used to identify a tethered device through network addressing method can be directly altered or updated using a PLC network.

The third part of this invention is a handoff of an untethered device connected to a tethered device on a PLC network to a communication network. This means that an untethered device can be handed off from a PLC system attached to a wider PLC network to a conventional wireless network such as a cellular network or an 802.11 wireless network. A handoff also can occur between an untethered device connected to a communication network to a tethered device connected to a PLC network or vice versa. A handoff can also occur between an untethered device connected to a communication network to a mesh communication network connected to a PLC system or vice versa.

The method for handoff is divided into multiple parts. The first part is determining positioning or signal power of all untethered devices and tethered devices within wireless range. This can be accomplished by the tethered device, untethered device, or central server evaluating received signal power of all untethered devices and tethered device in which it can talk to. The positioning of all untethered device and tethered devices can be accomplished by triangulating the device by three neighboring wireless devices.

The second part is by varying or keeping constant the signal power output of all untethered devices in proportion to positioning or received signal power between each untethered device and farthest device within wireless range. This allows for the most optimal communication network. It allows for the untethered devices to achieve most optimal battery life and still keep constant connection with nearby tethered devices.

The third part of creating a handoff is by for varying or keeping constant the signal power output of all tethered devices in proportion to positioning or received signal power between each tethered device and farthest device within wireless range to create a new first cell radius with new wireless radius that may or may not overlap with a second cell radius. This creates a wireless network with less interference with other neighboring wireless networks.

The fourth part of creating a handoff is the evaluation if the positioning or received signal power of an untethered device is more optimally connected to a power line communication network, a communication network, or a mesh communication network connected to a power line communication system. The evaluation can be accomplished by an untethered device, a central office server, by a tethered device on a power line communication network, by a tethered device on a conventional communication system, or by a mesh network connected to either a conventional communication network or a power line communication network.

A fifth part of creating a handoff is communicating through the power line communication network, or through the communication network, or through a wireless communication to analyze a tethered device's or a communication network's or a mesh communication network's position or received signal power from the untethered device, and the capacity of the tethered device or the communication network or the mesh communication network to connect to the untethered device.

A six part of creating a handoff is for the untethered device to disconnect from the tethered device while the untethered device connects to a communication network. Also, a handoff can be created between the untethered device initially connected to a communication network within a first or a second cell to a tethered device within the first cell such that the untethered device disconnects from the communication network while the untethered device connects to the tethered device linked to a PLC network. Also, a handoff can be created between a communication network within a first cell or a second cell and a mesh communication network connected to a PLC system within the first cell or the second cell such that the untethered device disconnects from the communication network while the untethered device connects to the mesh communication network. Other methods of creating a handoff are possible without departing from the spirit and scope of the novel concepts of the invention.

The idea behind this presently preferred embodiment is to have a network of tethered devices integrated into sunlight detectors sitting atop of a street light. Wireless untethered devices move freely around, but always have a connection to the sunlight detectors. As an untethered device moves, it is handed off from one sunlight detector to another sunlight detector or from one sunlight detector to another communication network such as a cellular network.

From the foregoing, it will be observed that numerous variations and modifications can be effected without departing from the spirit and scope of the novel concept of the invention. It is to be understood that no limitation with respect to the specific methods and apparatus illustrated herein is intended or should be inferred, but provided to define the best mode of practice which this embodiment defines. It is, of course, intended to cover by the appended claims all such modifications as fall within the scope of the claims.

### Description of Additional Mode for Carrying Out Invention

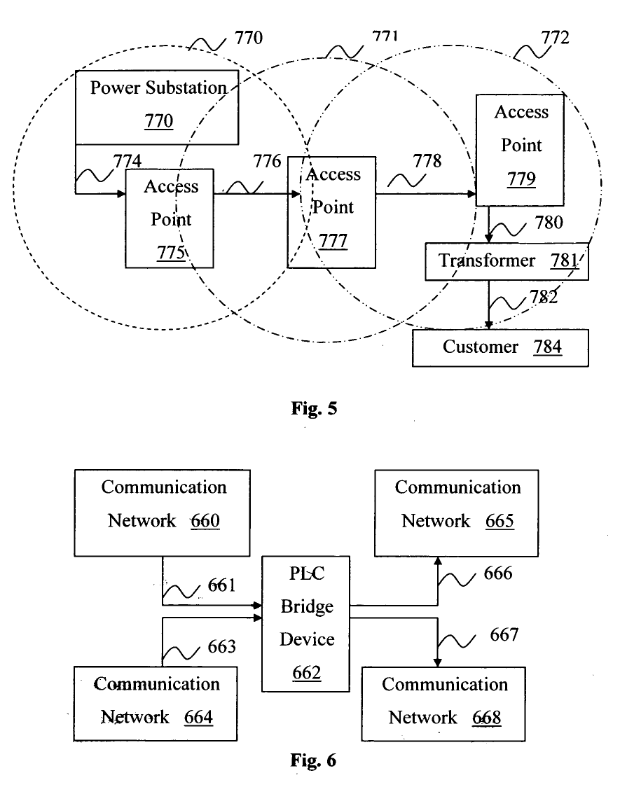

Referring now to FIG. 6, an additional embodiment in accordance with the present invention is described. A power line communication (PLC) bridge device 662 is used to switch first communication network 660 and second communication network 664 onto both third communication network 665 and fourth communication network 668. A power line communication bridge device 662 can also be used to switch either first communication network 660 or second communication 664 onto a power line communication network that is talking with either third communication network 665 or fourth communication network 668. Power line communication (PLC) bridge 662 may have the ability to communicate wirelessly using a protocol that does or does not support handoff. Power line communication (PLC) bridge 662 has the ability to communicate to first communication network 660 using a power line communication method or wireless method 661. Power line communication (PLC) bridge 662 may also has the ability to communicate to second communication network 664 using a power line communication method or wireless method 663. Power line communication (PLC) bridge 662 also has the ability to communicate to third communication network 665 using a power line communication method or wireless method 666. Power line communication (PLC) bridge 662 may also has the ability to communicate to the fourth communication network 668 using a power line communication method or wireless method 667. Power line communication (PLC) bridge 662 acts like a switch across the power line network such as to switch in and out the first communication network 660 and the second communication 664. Power line communication (PLC) bridge can send information from the first communication network 660 or the second communication network 664 over a power line communication method or wireless method 666 to a third communication network 665 and can send information from the first communication network 660 or the second communication 664 over a power line communication method or wireless method 667 to a fourth communication network 668 by switching in and out between the first communication network 660 or the second communication network 664.

### Operation of Additional Mode for Carrying Out Invention

The additional embodiment invention will be described in a specific context, namely a bridge device connected to a power line communication system that provides for handoff or switching in multiple communication networks or a single communication network onto a PLC network. The PLC system may be one tethered device that is connected to other devices to form a PLC network. A bridge device has the ability to communicate over a communication network which comprises a wireless network, a PLC network, an ATM network, an Ethernet network, a Gigabit Ethernet network, a PCI-Express network, a fiber optics network, a local area loop, a standard cellular network, a home power line network, a digital subscriber line network, a cable modem network, a cable television network, a copper line network, a plain old telephone subscriber line network, a packet based network, an 802.11 network, a Bluetooth network, a ultra-wideband network, or other similar network creating a mesh network. The bridge device can also take communication networks and bridge them onto multiple communication networks or a single communication network. The bridge device can act like a switch so as to switch in multiple communication networks onto a communication back end network or a different communication back end network or a single communication front end network onto a first communication back end network or a second communication back end network. Essentially, the PLC system can act like a bridge device between a single conventional communication network or multiple conventional communication networks to a different communication network. It can also switch in and out multiple front end communication networks onto multiple or a single backend conventional communication network. For example, a cellular line can be backhauled over a power line communication network to an ATM network. Each individual subscriber line can be switched into and out of the ATM network across the power line communication network.

From the foregoing, it will be observed that numerous variations and modifications can be effected without departing from the spirit and scope of the novel concept of the invention. It is to be understood that no limitation with respect to the specific methods and apparatus illustrated herein is intended or should be inferred, but provided to define the best mode of practice which this embodiment defines. It is, of course, intended to cover by the appended claims all such modifications as fall within the scope of the claims.

### INDUSTRIAL APPLICABILITY

Accordingly, the industrial applicability of this patent is for the selling of a product that allows a utility company to produce new revenue stream by transmitting and receiving wireless information from subscriber untethered devices. The utility company would use its extensive power line network to allow the transmitting and receiving of broadband information across the worldwide Internet to wireless subscriber devices. A utility company could also lease this backhaul power line communication network to cellular companies to sell minute usage on a GSM, GPRS, or 3G cellular systems.

### SEQUENCE LISTING

Not applicable

I claim:

1. A system for handoff [using a power line communication network, wherein said system] comprising:
a. [At least one untethered device with an ability to wirelessly communicate; and]
b. At least one tethered device with [an ability to wirelessly communicate and an ability to communicate using a] power line communication circuitry [system;], and
c. A means to perform a handoff, whereby an untethered device is handed off from a first base station to a second base station. [said untethered device from said tethered device to at least one communication network, or from said communication network to said tethered device, or from said communication network and at least one mesh communication network connected to said power line communication system.]

2. [The system in accordance with claim 1, wherein said untethered device not physically connected to said power line communication network comprising:
a. An antenna;
b. A transceiver to send and receive information;
c. A bi-directional coupling means, between said transceiver and said antenna; and
d. A secure communication protocol used to identify said device through network addressing method that can be directly altered or updated using said power line communication network;]

3. [The system in accordance with claim 1, wherein said tethered device electrically connected to said power line communication network within a fist cell comprising:
a. An antenna;
b. A transceiver to send and receive information;
c. A bidirectional coupling means, between said transceiver and said antenna;
d. A power line communication system;
e. A bi-directional coupling means, between said transceiver and said power line communication system; and
f. A secure communication protocol used to identify said device through network addressing method that can be directly altered or updated using said power line communication network.]

4. [The system in accordance with claim 1, wherein said mesh communication network comprises several untethered devices individually wirelessly connected together so that the last untethered device is connected to a tethered device connected to a communication network so as to bridge the farthest untethered device onto said tethered device; or comprises an individual untethered device wirelessly connected to a tethered device connected to a communication network.]

5. [The system in accordance with claim 1, wherein said communication network within said first cell or a second cell can comprise a mesh communication network which can be several untethered devices individually wirelessly connected together so that the last untethered device is connected to a tethered device connected to a communication network so as to bridge the farthest untethered device onto said tethered device or can comprise an individual untethered device wirelessly connected to a tethered device connected to a communication network comprising a power line communication network, an ATM network, an Ethernet network, a Gigabit Ethernet network, a PCI-Express network, a fiber optics network, a local area loop, a standard cellular network, a home power line network, a digital subscriber line network, a cable modem network, a cable television network, a copper line network, a plain old telephone subscriber line network, a packet based network, an 802.11 network, a Bluetooth network, a ultra-wideband network, or other similar network creating a mesh network.]

6. The system for handoff in accordance with claim 1, wherein said first base station or said second base station are connected to a communication network whereby said communication network may be an individual or plurality of other bridge devices, a wireless network. [can be a tethered device connected to a network comprising] a power line communication network, an ATM network, an Ethernet network, a Gigabit Ethernet network, a PCI-Express network, a fiber optics network, a local area loop, a [standard] cellular network, a home power line network, a digital subscriber line network, a cable modem network, a cable television network, a copper line network, a plain old telephone [subscriber line] network, a packet based network, an 802.11 network, an 802.16 network, an 802.20 network, a Bluetooth network, [a ultrawideband] an ultra wideband network, or other similar network creating a mesh network.

7. The system for handoff in accordance with claim 1, wherein said means to Perform a handoff [said untethered device between said tethered device within said first cell to said communication network within said first cell or said second cell, or between said communication network within said first cell or said second cell to said tethered device within said first cell, or between said communication network within said first cell or said second cell and said mesh communication network wired to a power line communication system within said first cell or said second cell] comprising:
a. [A means for] determining [positioning or signal power of all] data with respect to untethered devices, [and tethered devices within wireless range; and]
b. [A means for varying or keeping constant the signal power output of all untethered devices in proportion to positioning or received signal power between each untethered device and farthest device within wireless range; and]
c. [A means for varying or keeping constant the signal power output of all tethered devices in proportion to positioning or received signal power between each tethered device and farthest device within wireless range to create a new first cell with new wireless radius that may or may not overlap with said second cell; and]
d. [A means for] evaluating [if the positioning or received signal power of said untethered device is more optimally connected to said communication network, said mesh communication network connected to a power line communication system, or said tethered device; and] said data in relation to a requirement, and
e. [A means for communicating through said power transmission line communication network, or through said wired network, or through wireless communication to analyze said tethered device's or said communication network's or said mesh communication network's position or received signal power from said untethered device, and the capacity of said tethered device or said communication network device or said mesh communication network to connect to said untethered device; and]
f. [A means to handoff] handing off said untethered device when said requirement is met, whereby [from] said [tethered] untethered device [within said first cell to said communication network within said first cell or said second cell such that the first untethered device disconnects from the second tethered device while the second tethered device connects to said communication network, or from said communication network within said first or said second cell to said tethered device within the first cell such that said untethered device disconnects from said communication network while said untethered device connects to said tethered device, or from said communication network within said first cell or said second cell and said mesh communication network connected to a power line communication system within said first or said second cell such that said untethered device disconnects from said communication network while said untethered device connects to said mesh communication network.] is handed off from said first base station to said second base station.

8. The system in accordance with claim 1, wherein said tethered device is coupled to a physical interface whereby said physical interface is [can be entirely housed in] a [sunlight] photo detector socket [attached to a utility pole or street light], [or in an apparatus screwed into] a light bulb socket, an electrical outlet, [or] an enclosure [inductively attaching] attached inductively around a power transmission line, [or] an enclosure entirely housed in a sunlight photo detector attached to a photo detector socket on a utility pole or street light, a means to interface spliced into a light fixture, a means to interface spliced into a power transformer, or a means to interface spliced into an electric meter. [plugging into an electrical outlet, or an enclosure hanging from a utility pole.]

9. The system for handoff in accordance with claim 1, wherein [said tethered or] said untethered device [can communicate] communicates using either wireless, infrared, ultraviolet, laser, visible light, magnetic, ultrasonic, acoustic, impulse, [ultra-wideband] ultra wideband, [or] electromagnetic energy [and use any] or a combination [or individual protocol of Bluetooth,] of these communication methods, and said tethered device communicates using either power line, wireless, infrared, ultraviolet, laser, visible light, magnetic, ultrasonic, acoustic, impulse, ultra wideband, electromagnetic energy or a combination of these communication methods, and said means to perform a handoff is according to IEEE 802.16, IEEE 802.20. IEEE 802.15, IEEE 802.11 including IEEE 802.11e, ultra-wideband, GSM, CDMA, EDGE, GPRS, [CDMA,] TDMA, WCDMA, CDMA2000, 3G, 4G, OFDM, flash OFDM specification or according to another[, or other] communication [method] protocol supporting handoff.

10. [A] The system for handoff in accordance with claim 1, wherein said tethered or said untethered device can also communicate [with different devices or communication networks] using a [communication] method or protocol that does not support handoff.

11. [The system in accordance with claim 1, wherein said power line communication system can be implemented using direct spread spectrum, frequency hopping, magnetic, OFDM, ultra-wideband, impulse, or other communication method supporting power transmission line communication.]

12. The system for handoff in accordance with claim 1, wherein said tethered device [attached to said power line communication system] can repeat data from other tethered devices [attached to said power line communication network or repeat data from] or other [tethered] untethered devices [attached to said] associated with the same communication network or [repeat information from said mesh] a different communication network [or repeat information from a wireless network or repeat data from other networks in which said tethered device can communicate].

13. The system for handoff in accordance with claim 1, wherein said tethered device can track and locate untethered devices including mobile phones monetary instruments, and individuals, and based on this real time positioning securely broadcast multimedia content whereby said untethered device stores the content according to digital rights management. [transmit and receive explicit advertising, HDTV, radio, voice, video graphics, geographic content, or other information in accordance with a specific regional security.]

14. The system for handoff in accordance with claim 1, wherein said tethered device does not integrate a receiver [where said receiver is located in a different location such that said tethered device uses a co-located receiver over said power line communication network or said communication network as if said transmitter was located in said tethered device;] or does not integrate a transmitter [where] whereby said receiver or said transmitter is located in a different location such that said tethered device uses a co-located receiver or a co-located transmitter over said [power line] communication network, or said mesh communication network or said power line communication network as if said receiver or transmitter was located in said tethered device[; or does not integrate both a transmitter and receiver where said transmitter and receiver is located in a different location such that said tethered device uses a co-located transmitter and receiver over said power line communication network or said communication network as if said transmitter and receiver was located in said tethered device].

15. A [system for switching using a power line] communication switch [network, wherein said system] comprising:
a. [A] abridge [device] with [the ability to communicate over a] power line communication [network with at least one first communication network linked into said bridge device and with at least one second communication network linked out of said bridge device;] circuitry, and
b. [A] a means for switching. [to switch in to the front end of said power line communication network from said first communication network to at least one third communication network using said bridge device or a means to switch out of the back end of said power line communication network from said second communication network to at least one fourth communication network using said bridge device or a means to switch in to the front end and out of the back end of said power line communication network from said first communication network to at least one third communication network into said bridge device and from said second communication network to at least one fourth communication network out of said bridge device.]

16. The [system] communication switch in accordance with claim 15, wherein said [first communication network and said second communication network comprises] bridge has the ability to communicate over a communication network which comprises an individual or plurality of other bridge devices, a power plane network associated with the power pins of semiconductor chips, a wireless network, a power line communication network, an ATM network, an Ethernet network, a Gigabit Ethernet network, a PCI-Express network, a fiber optics network, a local area loop, a [standard] cellular network, a home power line network, a digital subscriber line network, a cable modem network, a cable television network, a copper line network, a plain old telephone [subscriber line] network, a packet based network, an 802.11 network, an 802.16 network, an 802.20 network, a Bluetooth network, a [ultra-wideband] ultra wideband network, or other similar network creating a mesh network.

17. The [system] bridge in accordance with claim [15]21, wherein said means [to switch in to the front end of said power line communication network from said first communication network to at least one third communication network using said bridge device or a means to switch out of the back end of said power line communication network from said second communication network to at least one fourth communication network using said bridge device or a means to switch in to the front end and out of the back end of said power line communication network from said first communication network to at least one third communication network into said bridge device and from said second communication network to at least one fourth communication network out of] for switching using said bridge device comprising:
a. [A means to connect said first communication network, said second communication network, said third communication network, or said fourth communication network through said bridge device such that an individual communication network can communicate over said power line communication network; and
b. A means to connect said bridge device with said power line communication network using a power line communication system such that said power line communication network can communicate with said first communication network, said second communication network, said third communication network, or said fourth communication network; and]
c. [A means to disconnect] disconnecting said [first] second communication network [with said power line communication network while connecting said third communication network with said power line communication network using said bridge device or a means to disconnect said second communication network with said power line communication network while connecting said fourth communication network with said power line communication system using said bridge device or a means to disconnect both first communication network and second communication network with said power line communication network while connecting both third communication network and fourth communication network with said power line communication network using] from said bridge device[.],and
d. connecting at least one third communication network to said bridge such that said bridge joins together said first communication network with said third communication network whereby said bridge acts as an integral part of the backbone of the joining of the first and third communication network.

18. [The system in accordance with claim 15, wherein said bridge device has the ability to communicate over a communication network which comprises a mesh communication network which can be several untethered devices individually wirelessly connected together so that the last untethered device is connected to a tethered device connected to a communication network so as to bridge the farthest untethered device onto said tethered device or can comprise an individual untethered device wirelessly connected to a tethered device connected to a communication network comprising a power line communication network, an ATM network, an Ethernet network, a Gigabit Ethernet network, a PCI-Express network, a fiber optics network, a local area loop, a standard cellular network, a home power line network, a digital subscriber line network, a cable modem network, a cable television network, a copper line network, a plain old telephone subscriber line network, a packet based network, an 802.11 network, a Bluetooth network, a ultra-wideband network, or other similar network creating a mesh network.]

19. [The system in accordance with claim 15, wherein said bridge device has the ability to communicate over a communication network which comprises a wireless network, a power line communication network, an ATM network, an Ethernet network, a Gigabit Ethernet network, a PCI-Express network, a fiber optics network, a local area loop, a standard cellular network, a home power line network, a digital subscriber line network, a cable modem network, a cable television network, a copper line network, a plain old telephone subscriber line network, a packet based network, an 802.11 network, a Bluetooth network, a ultra-wideband network, or other similar network creating a mesh network.]

20. [A method for power line communication system handoff comprising:
a. A means for determining positioning or signal power of all untethered devices and tethered devices within wireless range; and
b. A means for varying or keeping constant the signal power output of all untethered devices in proportion to positioning or received signal power between each untethered device and farthest device within wireless range; and
c. A means for varying or keeping constant the signal power output of all tethered devices in proportion to positioning or received signal power between each tethered device and farthest device within wireless range to create a new first cell with new wireless radius that may or may not overlap with a second cell; and
d. A means for evaluating if the positioning or received signal power of an untethered device is more optimally connected to a power line communication network, a communication network, a mesh communication network connected to a power line communication system, or a tethered device; and
e. A means for communicating through said power line communication network, or through said communication network, or through wireless communication to analyze said tethered device's or said communication network's or said mesh communication network's position or received signal power from said untethered device, and the capacity of said tethered device or said communication network or said mesh communication network to connect to said untethered device; and
f. A means to handoff said untethered device between said tethered device within said first cell to said communication network within said first cell or said second cell such that said untethered device disconnects from said tethered device while said untethered device connects to said communication network, or between said communication network within said first or said second cell to said tethered device within said first cell such that said untethered device disconnects from said communication network while said untethered device connects to said tethered device, or between said communication network within said first cell or said second cell and said mesh communication network connected to said power line communication system within said first cell or said second cell such that said untethered device disconnects from the said communication network while said untethered device connects to said mesh communication network.]

21. The communication switch in accordance with claim 15 wherein said bridge joins together at least one first communication network with at least one second communication network whereby said bridge acts as an integral part of the backbone of the joining of the first and second communication network.

22. The communication switching in accordance with claim 15, wherein
a. said bridge acts as an integral part of the backbone of at least one first communication network with at least one associated first cell and at least one second communication network with at least one associated second cell whereby said bridge loins together said first communication network and said second communication network,
b. said first communication network and said second communication network may or may not be the identical communication network,
c. said first cell may or may not overlap with said second cell,
d. at least one untethered device is communicating within said first cell using said first communication network, and
e. said means for switching disconnects said untethered device from said first cell and connects said untethered device to said second cell whereby said untethered device is switched from said first communication network to said second communication network.

23. A device for handoff comprising:
a. a communication circuitry,
b. a physical interface, wherein said physical interface is a photo detector socket, and
c. a means to perform a handoff using said communication circuitry.

24. The physical interface in accordance with claim 23, wherein said photo detector socket may be substituted by a light bulb socket, a means to interface spliced into a light fixture, a means to interface attached around or spliced into a power transmission line, a means to interface spliced into a power transformer, or a means to interface spliced into an electric meter.

25. The device for handoff in accordance with claim 24, wherein said means to perform a handoff is communicating through said physical interface by said communication circuitry and said photo detector socket may be substituted by an electrical outlet.

26. The device for handoff in accordance with claim 23, wherein said communication circuitry communicates using either power line, wireless, infrared, ultraviolet, laser, visible light magnetic, ultrasonic, acoustic, impulse, ultra wideband, electromagnetic energy or a combination of these communication methods, and said means to perform a handoff is according to GSM, CDMA, EDGE, GPRS, TDMA, WCDMA, CDMA2000, OFDM, flash OFDM, 3G, 4G, IEEE 802.16, IEEE 802.20, IEEE 802.15, or IEEE 802.11 specification including IEEE 802.11e or according to another communication protocol supporting handoff.

27. The system for handoff in accordance with claim 8, wherein said means to perform a handoff is communicating through said physical interface by said tethered device.

28. The system for handoff in accordance with claim 1, wherein said tethered device is said first base station and a different tethered device is said second base station.
